(19) United States
(12) Patent Application Publication
(10) Pub. No.: US 2026/0254646 A1
(43) Pub. Date: Aug. 27, 2026

(54) Method and Apparatus for Managing Digital Content Rights and Interaction

(71) Applicant: Brian Bender, Los Angeles, CA (US)

(72) Inventor: Brian Bender, Los Angeles, CA (US)

(21) Appl. No.: 19/462,465

(22) Filed: Jan. 28, 2026

Related U.S. Application Data
(60) Provisional application No. 63/750,372, filed on Jan. 28, 2025.

(51) Int. Cl. H04L 9/32

(52) U.S. Cl. CPC H04L 9/3213; H04L 9/3236; H04L 9/3247; H04L 2209/603

(57) ABSTRACT

A content management device is configured to generate a universal rights dual-layer token associated with a given digital content element. The dual-layer token functions as rights container class that holds public-facing data associated with the digital content element for the public good along with private data, such as rights holder information associated with the digital content element. Accordingly, the dual-layer token stores pertinent information associated with the digital content element as part of a single, digital instrument that can be deployed at industry scale for any digital industry. The dual-layer token provides real-world intellectual property integration of digital content by mapping existing ownership and creative rights as part of a distributed ledger, by providing a territory-agnostic framework for enforcement of those rights, and by complying with existing legal frameworks.

### RELATED APPLICATIONS

This patent application claims the benefit of U.S. Provisional Application No. 63/750,372, filed on Jan. 28, 2025, entitled “Method and Apparatus for Providing Digital Content Management,” the contents and teachings of which are hereby incorporated by reference in their entirety.

### BACKGROUND

The distribution of digital media content (e.g., music, video, artwork, etc.) has moved from traditional real-world channels to computer-network distribution or online channels. For example, audio streaming services routinely provide consumers with digital music content via online portals.

With conventional digital media content, particularly digital music content, a content creator typically registers the content with a performance rights organization (e.g., ASCAP, BMI, etc.) and can collect royalites from these organizations based upon use of the content. Accordingly, content distributors, such as online audio content distributors and audio streaming services, utilize a variety of management mechanisms to track activity or use of digital media content in order to provide the performance rights organization with content use information so that the creators can be compensated appropriately.

For example, content distributors can utilize conventional digital rights management (DRM) systems to control and track a user's access to the digital content or can use software-as-a-service (SaaS) and ad-tech logs to capture user impressions of a platform advertisement to measure platform activity. Further, content distributors can utilize Blockchain Non-Fungible Tokens (NFTs) to prove ownership and authenticity of the digital content or artificial intelligence (AI) provenance tools to track data usage.

### SUMMARY

The management mechanisms utilized to track activity or use of digital media content, such as used by online audio content distributors and audio streaming services, suffer from a variety of deficiencies. For example, while conventional DRM systems track access to the digital content, these systems hide usage logs and do not produce auditable, neutral records. Further, while SaaS and ad-tech logs measure platform activity, the data these systems produce is typically proprietary and unverifiable by third-party organizations. Additionally, while content distributors can utilize Blockchain NFTs to prove ownership of digital media, conventional NFTs do not reflect real-world usage of the digital media. As such, NFTs do not assist with the monetization of digital media content by or on behalf of the content creators or owners. Lastly, while AI tools can track digital media content usage, these tool typically do not enforce payments based upon that usage.

Accordingly, with the use of conventional management tools, tracking the use of digital media content by online content distributors, for example by audio streaming services, can be inaccurate and error prone. As such, in the case of monetization of the digital media content by or on behalf of the content creators or owners, these inaccuracies can lead to erroneous, and likely reduced, compensation.

By contrast to conventional digital media content tracking mechanisms, embodiments of the present innovation relate to a method and apparatus for managing digital content rights and interaction. In one arrangement, a content management device is configured to generate a universal rights dual-layer token associated with a given digital content element. The dual-layer token functions as rights container class that holds public-facing data associated with the digital content element for the public good along with private data, such as rights holder information associated with the digital content element. Accordingly, the dual-layer token stores pertinent information associated with the digital content element as part of a single, digital instrument that can be deployed at industry scale for any digital industry.

In one arrangement, the dual-layer token provides real-world intellectual property integration of a digital content element by mapping existing ownership and creative rights as part of a distributed ledger, by providing a territory-agnostic framework for enforcement of those rights, and by complying with existing legal frameworks. Further, the dual-layer token can include a first layer that allows for public verification of publicly accessible performance metadata and technical specifications associated with the digital content, as well as a second layer that provides secure private rights management to non-public information related to the content, such as revenue allocation structures and payment routing instructions, as part of an immutable public record. Additionally, the universal rights dual-layer token includes a unique identifier that allows for cross-platform compatibility as well as rights verification of the digital content element

Further, the content management device is configured to track actual use of the digital content element. For example, in the case where an end user accesses the digital content element via a content distributor, such as via a streaming service, such access causes the content distributor to generate and transmit consumption event notifications to the content management device. The content management device, in turn can aggregate all of the notifications as part of a single notification batch and can register the notification batch on the distributed ledger as proof of access or consumption of the digital content elements. As such, the content management device provides trustless backing for existing consumption tracking systems while maintaining compatibility with territory-specific copyright enforcement frameworks. The content management device also allows for instantly verifiable consumption statistics of a digital content element, for settlement and enforcement, at a fixed cost, regardless of consumption volume.

Embodiments of the innovation relate to, in a content management device, a method of managing interaction with a digital content element. The method comprises receiving, by the content management device, public information associated with the digital content element and private information associated with the digital content element to register the digital content element with the content management device; generating, by the content management device, a dual-layer token having a first layer based upon the public information associated with the digital content element and a second layer based upon the private information associated with the digital content element; and registering, by the content management device, the dual-layer token on a distributed ledger. The method comprises receiving, by the content management device, consumption event notifications associated with digital content elements registered with the content management device; registering, by the content management device, the consumption event notifications as a notification batch on the distributed ledger, the notification batch providing immutable proof of a consumption event for a digital content element registered with the content management device; and generating, by the content management device, a compensation report related to consumption of the digital content element, the compensation report identifying the dual-layer token and the notification batch registered on the distributed ledger.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic depiction of a content management system, according to one arrangement.

FIG. 2 is a flowchart of a process performed by the content management device of FIG. 1 when managing digital content rights and interaction, according to one arrangement.

FIG. 3A illustrates a graphical user interface provided by the content management device of FIG. 1 requesting public information associated with a digital content element, according to one arrangement

FIG. 3B illustrates a graphical user interface provided by the content management device of FIG. 1 requesting public information associated with a digital content element, according to one arrangement.

FIG. 4 illustrates a graphical user interface provided by the content management device of FIG. 1 requesting private information associated with a digital content element, according to one arrangement.

FIG. 5 illustrates is a flowchart of a process performed by the content management device of FIG. 1, according to one arrangement

FIG. 6 illustrates a schematic depiction of a content management system, according to one arrangement

FIG. 7 illustrates a schematic depiction of a content management system, according to one arrangement.

FIG. 8 illustrates a graphical user interface provided by the content management device of FIG. 1 requesting artificial intelligence training permission associated with a digital content element, according to one arrangement

FIG. 9 illustrates a schematic depiction of a content management system, according to one arrangement.

### DETAILED DESCRIPTION

Embodiments of the present innovation relate to a method and apparatus for managing digital content rights and interaction. In one arrangement, a content management device is configured to generate a universal rights dual-layer token associated with a given digital content element. The dual-layer token functions as rights container class that holds public-facing data associated with the digital content element for the public good along with private data, such as rights holder information associated with the digital content element. Accordingly, the dual-layer token stores pertinent information associated with the digital content element as part of a single, digital instrument that can be deployed at industry scale for any digital industry.

In one arrangement, the dual-layer token provides real-world intellectual property integration of digital content by mapping existing ownership and creative rights as part of a distributed ledger, by providing a territory-agnostic framework for enforcement of those rights, and by complying with existing legal frameworks. Further, the dual-layer token can include a first layer that allows for public verification of publicly accessible performance metadata and technical specifications associated with the digital content, as well as a second layer that provides secure private rights management to non-public information related to the content, such as revenue allocation structures and payment routing instructions, as part of an immutable public record. Additionally, the universal rights dual-layer token includes a unique identifier that allows for cross-platform compatibility as well as rights verification of the digital content element.

Further, the content management device is configured to track actual use of the digital content element. For example, in the case where an end user accesses the digital content element via a content distributor, such as via a streaming service, such access causes the content distributor to generate and transmit consumption event notifications to the content management device. The content management device, in turn can aggregate all of the notifications as part of a single notification batch and can register the notification batch on the distributed ledger as proof of access or consumption of the digital content elements. As such, the content management device provides trustless backing for existing consumption tracking systems while maintaining compatibility with territory-specific copyright enforcement frameworks. The content management device also allows for instantly verifiable consumption statistics of a digital content element, for settlement and enforcement, at a fixed cost, regardless of consumption volume.

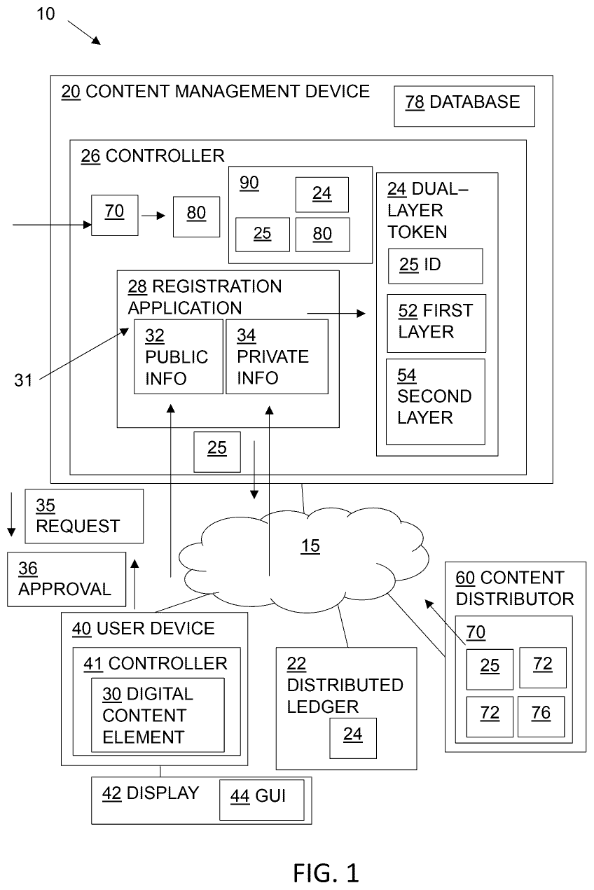

FIG. 1 illustrates a content management system 10, according to one arrangement. As illustrated, the content management system 10 includes a content management device 20 disposed in electrical communication with a distributed ledger 22, such as blockchain, via a network 15 such as a local area network (LAN), a wide area network (WAN), or a public switched telephone network (PSTN).

The content management device 20 is configured to provide management, such as tracking the use, of a digital content element 30, such as digital audio content, by online content distributors 27, such as online audio content distributors and streaming services. To assist with the management of the digital content element 30, the content management device 20 is configured to generate a universal rights dual-layer token 24 (hereinafter “dual-layer token”) associated with a digital content element 30. For example, the content management device 20 includes a controller 26, such as a memory and a processor, which, in one arrangement, is configured to execute a registration application 28 to generate the dual-layer token 24 based upon information related to the digital content element 30.

The digital content element 30 can be configured in a variety of ways. For example, the digital content element 30 can be configured as a digital audio file, such as a *.MP3, *.WAV, *.AIFF, or *.FLAC file, for example. In another example, the digital content element 30 can be configured as a digital text file, such as a *.DOC or *.TXT file. In another example, the digital content element 30 can be configured as a digital image file, such as a *.JPG or *.PNG file. In another example the digital content element 30 can be configured as a file that includes a combination of digital audio, digital text, and/or digital images.

As will be described in detail below, the dual-layer token 24 is a digital asset configured as a container class which includes both public and private facing data associated with the digital content element 30. As such, the dual-layer token 24 provides a centralized repository for metadata associated with the digital content element 30. Further, the dual-layer token 24 includes a unique identifier 25, such as a bar code, associated with the digital content element 30. This unique identifier 25 can be provided to an end user (e.g., radio broadcasters, internet streaming services, etc.) of the digital content element 30 for tracking of the use of the content element 30.

The distributed ledger 22, such as blockchain, is shared across a number of computerized devices and is configured to record transactions associated with the dual-layer token 24 in a verifiable and permanent manner. For example, the distributed ledger 22 is disposed across a peer-to-peer or distributed network 56 that is configured to manage financial information, transactions, and/or other data associated with the dual-layer token 24 using a protocol for internode communication and validating new tokens or blocks. Each block can include a cryptographic hash of the previous block, a timestamp, and transaction data. Once recorded as part of the distributed ledger 22, the data in any given block cannot be altered retroactively without alteration of all subsequent blocks, which requires consensus of a majority of participants within the distributed network 56. The distributed ledger 22, provides a level of immutability to the dual-layer token 24 registered thereon.

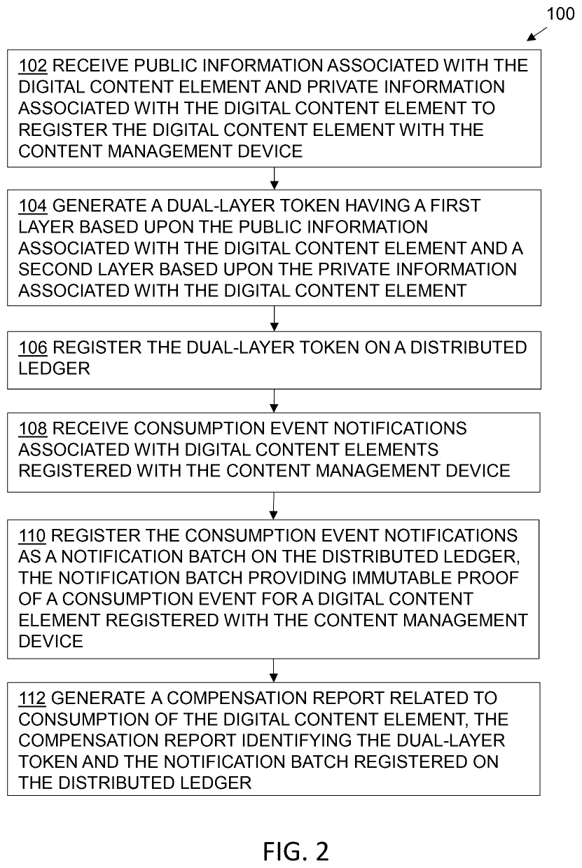

FIG. 2 is a flowchart 100 of a process performed by a content management device 20 when managing rights and interaction with a digital content element 30, according to one arrangement.

In element 102, the content management device 20 is configured to receive public information 32 and private information 34 associated with the digital content element 30.

For example, when a content creator or content owner (i.e., user) generates a digital content element 30, such as a music or image file, the user can register the digital content element 30 (e.g., copyright-protected music, video, images, or text) as part of the content management system 10 via the content management device 20. In one arrangement, the user can access the content management device 20 via a web browser executed by a user device 40, such as a computerized device having a controller 41, such as a memory and a processor, disposed in electrical communication with the content management device 20 via the network 15. With such access, the content management device can execute the registration application 28 and can provide a graphical user interface (GUI) 44, such as a web2 interface, to the end user via a display 42, requesting the user to provide digital content element information 31 related to the digital content element 30.

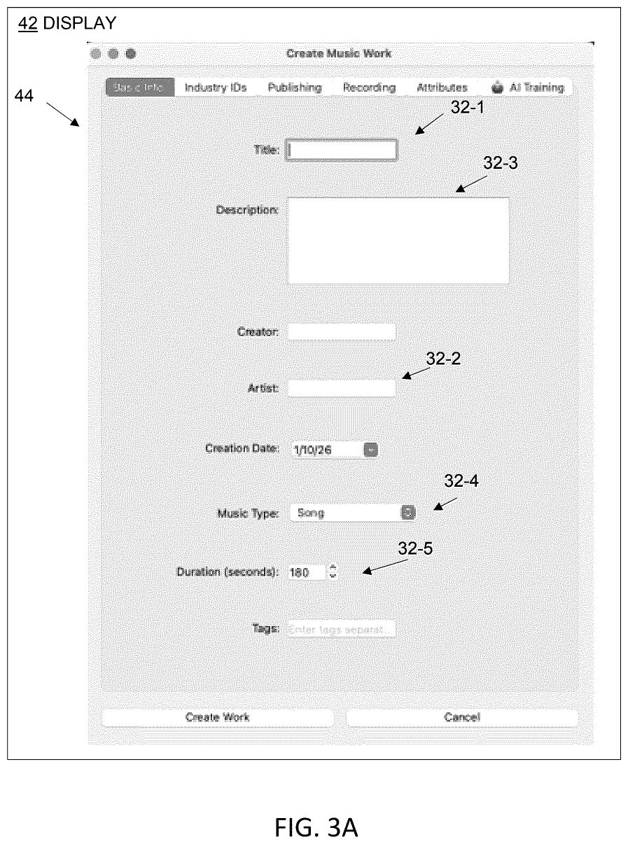

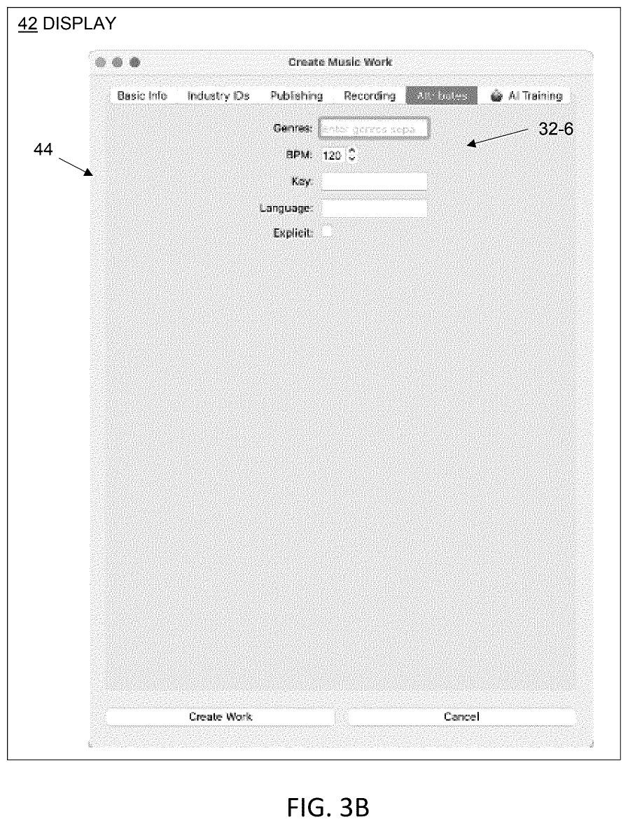

For example, the content management device 20 can request, as digital content element information 31, the entry of public information 32 associated with the digital content element 30 via the GUI 44. In one arrangement, as indicated in FIG. 3A, the public information 32 provided by the end user can include information related to the digital content element 30 that is intended to be accessible by the public to promote transparency. For example, the public information 32 can include, in the case of an audio digital content element 30, publicly accessible performance metadata associated with the digital content element 30 such as, a title 32-1, artist name 32-2, content description 32-3, music type 32-4, duration 32-5, recording credits, performance credits, songwriting credits, recording location, or recording date, associated with the digital content element 30. Further, as shown in FIG. 3B, the public information 32 can also include technical specifications 32-6 associated with the digital content element 30 such as genre, play counts, beats-per-minute (BPM), or vibe.

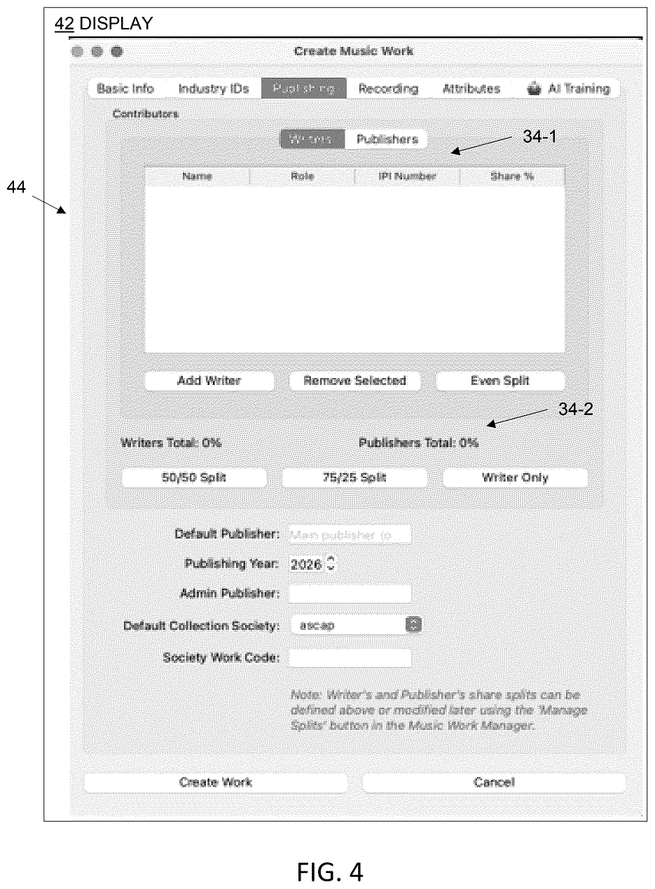

In another example, as indicated in FIG. 4, the content management device 20 can request, as digital content element information 31, the entry of private information 34 associated with the digital content element 30 via the GUI 44. In one arrangement, the private information 34 can be content rights information related to financial aspects or monetization aspects of the digital content element 30 that is not intended to be accessible by the public. For example, the private information 34 can include an ownership percentage 34-1 and a revenue allocation structure 34-2, such as publishing splits and master recording splits, associated with the digital content element 30. The private information 34 can also include mechanical reproduction rules, territory agnostic license rights, territory-specific distribution rules and/or ownership structures, and payment routing instructions.

Returning to FIG. 2, in element 104, the content management device 20 is configured to generate a dual-layer token 24 having a first layer based upon the public information 32 associated with the digital content element 30 and a second layer based upon the private information 34 associated with the digital content element 30. For example, following receipt of the digital content element information 31, with further execution of the registration application 28, the content management device 20 can generate the dual-layer token 24 associated with the digital content element 30. The first layer 52 is configured as a public-facing layer and includes the publicly accessible performance metadata and technical specifications provided as part of the public information 32. The first layer 52 can provide public metadata as an application programming interface (API) associated with the digital content element 30 for a business facing toolset which can then be provided to digital content distributors. The second layer 54 is configured as a private-facing layer and includes the data provided as part of the private information 34. In one arrangement, the second layer 54 is configured to identify ownership and transaction information with respect to the digital content element 30. For example, the second layer 54 can include revenue allocation structures, such as a share identifier identifies shares or splits associated with the digital content element 30, territory-specific distribution rules, payment routing instructions, and a description of international laws identifying remediation of intellectual property rights associated with the digital content element 30.

Also, when generating the dual-layer token 24, the content management device 20 is configured to verify the ownership of the digital content element 30. In one arrangement, the content management device 20 is configured to generate and transmit a request 35 to all intellectual property (IP) rights owners of the digital content element 30 (e.g., songwriters listed in the songwriting credits of the public information 32 and/or identified in the private information 34) to confirm ownership. For example, the content management device 20 can generate, as the request 35, a checksum and can forward the checksum to each IP rights owner listed in the ownership percentage of the private information 34. Following receipt of the request 35, each owner can generate an approval notification 36 (e.g., a digital signature using a private key), such as through the GUI 44, and provide the notification 36 to the content management device 20.

Following the receipt of the approval notification 36, the content management device 20 executes the registration application 28 to generate the dual-layer token 24 along with a unique identifier 25 associated with the digital content element 30. The unique identifier 25 is configured to allow public verification of the public information 32 associated with the digital content element 30 while maintaining the data security of the private information 34. In one arrangement, the content management device 20 is configured to transmit the unique identifier 25 to the user device 40 to allow the end user to include the identifier as part of the metadata associated with the digital content element 30. The data storage capacity of the unique identifier 25 is small enough to be retrofit into existing metadata allowances for conventional digital content elements 30 while robust enough to enable any number of variables to be linked to that unique identifier 25 (e.g., hyperlinks, etc.). While the unique identifier 25 can be configured in a variety of ways, in one arrangement the unique identifier 25 is configured as a bar code.

In element 106, the content management device 20 is configured to register the dual-layer token 24 on a distributed ledger 22. For example, the content management device 20 can store the dual-layer token 24 as two separate structures-the first layer 52 and unique identifier 25 stored in a public-facing layer of the block on the distributed ledger 22 and the second layer 54 and the unique identifier 25 stored in a private-facing layer of the block on the distributed ledger 22. In response, once the dual-layer token 24 registration is confirmed by the distributed ledger 22, the content management device 20 forwards a registration confirmation 62 and the unique identifier 25 for the digital content element 30 to the user device 40.

Accordingly, by generating the dual-layer token 24 having both public and private layers 52, 52 and registering the dual-layer token 24 as a block on a distributed ledger 22, the content management device 20 centralizes both contributor metadata and ownership rights data associated with a digital content element 30, as well as provides a level of trustworthiness and immutability of that data. As such, the content management device 20 allows for fair administration and distribution of any royalties or assets to the owner, as generated by monetization of the content element 30.

Further, by generating the dual-layer token 24 having both public and private layers 52, 52, the content management device 20 can provide content distributors 27 with a single, unified reporting system and output point to simplify reporting. For example, and as will be described below, content distributors 27 can access the dual-layer token 24 on the distributed ledger 22 to identify the appropriate parties to be compensated for use of the digital content. Additionally, by registering the dual-layer token 24 on the distributed ledger 22, the content management device 20 can provide Performance Rights Organizations and artists with a single, unified reporting system and output point to simplify navigating income and income shares across all types of media and income stream. As such, the content management device 20 provides existing Performance Rights Organizations with trustless backing for the digital content element 30.

The content management device 20 is also configured to provide a trustless verification backing system with multi-layered security for consumption tracking of digital content elements 30.

Returning to FIG. 2, in element 108, the content management device 20 is configured to receive consumption event notifications 70 associated with the digital content elements 30 registered with the content management device 20.

In one arrangement, when an end user accesses digital content elements 30 presented by a content distributor 60, the content distributor 60 is configured to generate corresponding consumption event notifications 70. For example, in the case where the digital content element 30 is a music file, the end user can play the digital content element 30 through the content distributor 60, such as a streaming service. In response to playing the digital content element 30, the content distributor 60 is configured to generate and forward the consumption event notification 70 to the content management device 20. In response to receiving the consumption event notification 70, the content management device 20 is configured to store the consumption event notification 70 in a database 78, such as a local database, distinct from the distributed ledger (i.e., off chain).

While the consumption event notification 70 can be configured in a variety of ways, in one arrangement, the consumption event notification 70 includes a unique identifier 25 associated with the digital content element 30, a content distributor identifier 72 (e.g., Spotify, YouTube, Apple Music, etc.), a timestamp 74 associated with a time of the consumption event (e.g., time of play of the digital content element 30), and a geographic origination identifier 76 associated with the consumption event and indicating a geographic location (e.g., a country code such as US, UK, etc.) associated with use of the digital content element 30. In one arrangement, the geographic origination identifier 76 maps to existing copyright tracking framework included as part of the dual-layer token 24.

In element 110, the content management device 20 is configured to register the consumption event notifications 70 as a notification batch 80 on the distributed ledger 22, the notification batch 80 providing immutable proof of a consumption event for a digital content element 30 registered with the content management device.

For example, over the course of a given time period, the content management device 20 can receive additional consumption event notifications 70 associated with the same or different digital content elements 30 provided by the content distributor 60. The content management device 20 can aggregate all of the notifications 70 as part of a single notification batch 80 as proof of access or consumption of the digital content elements 30 that have been registered with the content management device 20. Following such aggregation, the content management device 20 can store the notification batch 80 for the given time period as part of the database 78. The content management device 20 is also configured to register the notification batch 80 on the distributed ledger 22. As such, the content management device 20 can provide immutable proof of access or consumption of a given digital content element 30 to either the content distributor 60 or to a Performance Rights Organization.

In element 112, the content management device 20 is configured to generate compensation report 90 related to consumption of the digital content element 30, the compensation report 90 identifying the dual-layer token 24 and the notification batch 80 registered on the distributed ledger 22.

For example, the content management device 20 can be configured to assist with enforcing compensation rights for the owners of the digital content element 30. As such, the content management device 20 can prepare and forward the compensation report 90, such as an invoice, to third-party entities responsible for compensating the owners. For example, in the case where the digital content element 30 is digital audio content, the content management device 20 can forward the compensation report 90 to a content distributor 60 and/or to a Performance Rights Organization.

In order to ensure correct compensation for use of the digital content element 30, the content management device 20 can include an identification of the dual-layer token 24 registered on the distributed ledger 22 as part of the compensation report 90. For example, the content management device 20 can include the unique identifier 25 associated with both the digital content element 30 and the dual-layer token 24 as part of compensation report 90, along with a private key to access the private information 34 associated with the second layer 54 of the dual-layer token 24. As such, a third-party can identify the dual-layer token 24 associated with a particular digital content element 30 and review the associated private information 34 to determine the correct parties to be compensated, along with the compensation splits.

Further, the content management device 20 can include the identification of the notification batch 80 registered on the distributed ledger 22, along with identification of the number of consumption events the digital content element 30 experienced over a given timeframe as part of the compensation report 90. As such, a third-party can extract the number of consumption events for the digital content element 30 from the notification batch 80 and can verify that number with the number of consumption events reported by the content management device 20 to ensure a correspondence and an accurate accounting.

As such, by generating and registering the dual-layer token 24 with the distributed ledger 22, the content management device 20 centralizes both contributor metadata (i.e., public information 32) and secure private ownership rights data (i.e., private information 34) associated with a digital content element 30. As such, the content management device 20 provides content distributors 60, Performance Rights Organizations, and owners with a single, unified reporting system and output point, as part of an immutable public record, to simplify reporting of revenue allocation structures and payment routing instructions across all types of media and income streams. This allows for fair administration and distribution of any royalties or assets to the owner, as generated by monetization of the digital content element 30.

Additionally, the dual-layer token 24 can be used to retrofit existing IP definitions and payment definitions for those IP protection classes, by territory, into a single container. This makes the generation of instantly verifiable consumption statistics a relatively easy and automatic process. Reduction in friction for litigation and settlement around registration and payments reduces operational overhead and increases efficiency and transparency. Also, with generation and registration of the dual-layer token 24, the content management device 20 facilitates rights management and transfer of a digital content element 30. For example, with the public and private information 32, 34 accessible in a single container class on the distributed ledger 22, a digital content element owner, such as a composer, can adjust aspects of the dual-layer token 24 to identify a transfer of rights, assignment, or sub-assignment, to a rights management company, such as a publisher, or to identify a licensing status of the digital content element 30 (i.e., the digital content element owner can directly license synchronization usage of the digital content element 30 through the dual-layer token 24.

Further, the content management device 20 batches all plays or consumption events from all platforms into a single notification batch 80 and registers the notification batch 80 with the distributed ledger 22. As such, the content management device 20 provides content distributors 60 with the ability to compute and distribute compensation settlement for use of a given digital content element 30 based on verified, immutable data. Additionally, with generation and registration of the single notification batch 80 with the distributed ledger 22 over a given timeframe (e.g., once per day), the content management device 20 reduces the costs associated with distributed ledger registration. For example, registration of each consumption event with the distributed ledger 22 individually scales with consumption and can cost approximately $131Billion/year. By contrast, generating and registering a single notification batch 80 once per day can cost $730/year.

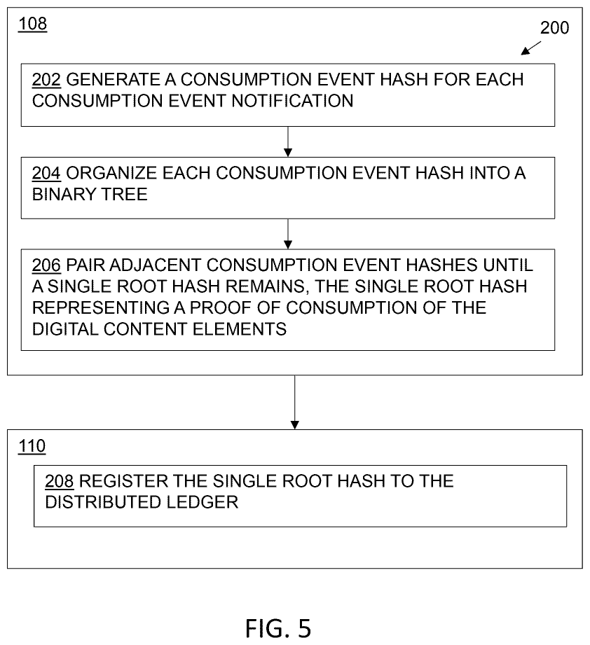

As provided above, during operation, as the content management device 20 receives consumption event notifications 70 over a given timeframe, the content management device 20 is configured to aggregate the consumption event notifications 70 as a notification batch 80 and to register the notification batch on the distributed ledger 22. In one arrangement, as will be described below with reference to the flowchart 200 of FIG. 5, the content management device 20 is configured to aggregate all consumption event notifications 70 from all content distributors into a single cryptographic tree. Once per a given timeframe (e.g., once per day), the content management device 20 can registers the root of the cryptographic tree with the distributed ledger 22. As such, any individual play or consumption event can later be verified by a third-party using a cryptographic proof.

For example, in element 202, the content management device 20 is configured to generate a consumption event hash for each consumption event notification 70.

As provided above, in response to a user engaging with or consuming a digital content element 30 (e.g., a user playing digital audio content on a streaming platform), the content distributor 60 generates a consumption event notification 70, such as a Merkle leaf, which includes a unique identifier 25 associated with the digital content element 30, a content distributor identifier 72, a timestamp 74, and a geographic origination identifier 76, for example. For each consumption event notification 70 received for a given time period (e.g., 24 hour timeframe), the content management device 20 stores the consumption event notification 70, along with a batch date, off of the distributed ledger 22, such as in the database 78.

At the conclusion of the time period, the content management device 20 is configured to aggregate all consumption events from that time period. For example, the content management device 20 can query the database for all consumption event notifications 70 received for a given batch date, can count the total number of consumption event notifications 70 and can count the number of unique identifiers 25 associated with the event notifications 70.

Next, the content management device 20 is configured to apply a hashing process to each consumption event notification 70. For example, the content management device 20 can create a canonical string for each consumption event notification 70 which includes “{token_id}: {distributor}:{timestamp}:{territory}” and can apply a hash function to the string, such as keccak256 (i.e., the Ethereum standard). The resulting consumption event hash for each consumption event notification 70 is a 32-byte hash (256 bits). In one arrangement, the content management device 20 can store each consumption event notification hash with the associated consumption event notification 70 in the database 78

In element 204, the content management device 20 is configured to organize each consumption event notification hash into a binary tree. For example, the content management device 20 is configured to distribute all consumption event notification hashes as leaves (i.e., bottom level) of the binary tree.

In element 206, the content management device 20 is configured to pair adjacent consumption event notification hashes until a single root hash remains, the single root hash representing a proof of consumption of the digital content elements 30. As such, the content management device 20 generates a cryptographic proof path associated with the consumption event notifications for a given timeframe.

For example, the content management device 20 is configured to hash each pair of adjacent consumption event notification hashes to create parent nodes. The content management device 20 can then repeat the process of pairing adjacent elements and hashing the adjacent elements to create a reduced set of parent nodes until a single root hash remains—a Merkle proof (e.g., the notification batch 80). The Merkle proof is a cryptographic proof that verifies a specific transaction, such as a particular consumption event notification 70 is part of a dataset without revealing the entire dataset, thereby providing immutability to that transaction.

Next, the content management device 20 is configured to generate a cryptographic proof path for each consumption event. For example, the content management device 20 can generate a Merkle proof for each consumption event notification 70 to enable verification without utilizing the full tree. The content management device 20 aggregates all associated consumption events 70 as part of the database 78. As such, the veracity of a single consumption event 70 can be cryptographically proven by against any single play event in the database 78 by referencing the consumption event 70, the sibling hashes in the tree from other consumption events 70, and the Merkle proof (e.g., the notification batch 80). The Merkle hashes are deterministic, originating from the final Merkle Root, so this arrangement additionally allows for the regeneration of correct hashes in the event of data corruption or compromise.

In element 208, the content management device 20 is configured to register the single root hash to the distributed ledger 22. For example, the content management device 20 can commit the Merkle root hash to the distributed ledger 22 in single transaction. While the transaction can be configured in a variety of ways, the transaction can include the Merkle root (32-byte hash), a total number of consumption events (total count across all platforms), a total of the number of particular digital content elements 30 that had consumption events (how many songs had plays), and a commitment date (timestamp of date committed).

With this process, in the case where the content management device 20 generates and provides a compensation report 90 to a third-party, the content management device 20 has immutable proof that the compensation report 90 is correct. For example, the content management device 20 can retrieve the Merkle proof (e.g., the notification batch 80) and the consumption event notification hash for a particular digital content element 30 from the database 78, along with the Merkle proof committed to the distributed ledger 22 and can include these elements as part of the compensation report 90. In one arrangement, such as in the case where the digital content element 30 is a digital audio element, the content management device 20 can issue identical compensation report 90 to both the content distributor 60 and the Performance Rights Management system, each containing the consumption event notification hash and Merkle proof associated with a given digital content element, thereby enabling independent cross-verification by both parties against the same committed root without requiring access to the other party's data.

As provided above, the content management device 20 is configured to generate the dual-layer token 24 as including public information 32 as part of a first layer 52. In certain cases, third-parties may want to query the public information metadata associated with the first layer 52. For example, in the case where the digital content element 30 is a music file, a hosting or streaming service (e.g., Spotify) or an existing copyright database wants to identify a creator associated with the digital content element 30.

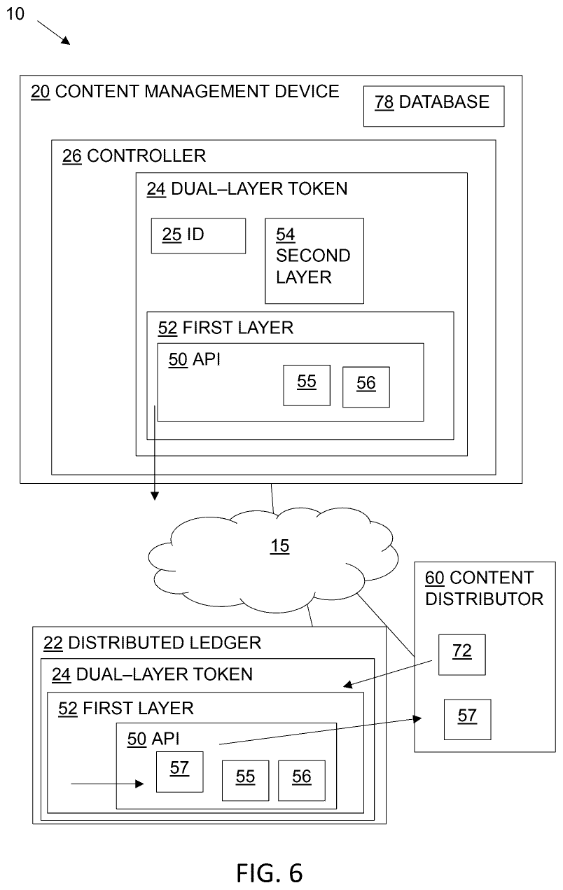

In one arrangement, to allow such access and with reference to FIG. 6, the content management device 20 is configured to incorporate a Representational State Transfer (REST) application programming interface (API) 50 as part of the first layer 52 of the dual-layer token 24. The REST API 50 is configured as an endpoint to provide public information metadata related to the digital content element 30 based upon a third-party request to create a two-way data stream. In the case where the digital content element 30 is a music file, the REST API 50 enables interoperability with existing copyright databases and rights administration systems.

In one arrangement, the REST API 50 includes a search endpoint 55, such as an HTTP address, for querying tokens 24 by artist, title, or other public metadata fields. The REST API 50 can also include a retrieval endpoint 56 for retrieving public metadata from a distributed ledger 22 by unique identifier 25. In one arrangement, the REST API 50 can include an endpoint for querying AI training permissions associated with the digital content element 30 without authentication.

During operation, assume the case where a content distributor 60, such as a streaming service, seeks to make payment for use of the digital content element 30 hosted by the content distributor 60 but requires creator information to do so. In such a case, the content distributor 60 transmits a request 60 to the HTTP address of the search endpoint 55 of the REST API 50 along with the unique identifier 25 associated with the digital content element 30. In response to receiving the request 72, a handler engine associated with the REST API 50 framework is configured to validate the dual-layer token 24 associated with the unique identifier 25 associated with the digital content element 30. For example, the handler engine can confirm that the dual-layer token 24 exists on the distributed ledger 22 and that the unique identifier 25 associated with the dual-layer token 24 is a positive integer.

In response to validating the dual-layer token 24, the REST API 50 framework is configured to query the distributed ledger 22 for public information 32 associated with the dual-layer token 24 associated with the unique identifier 25. For example, the REST API 50 framework can query the distributed ledger 22 for public information 32 via a public view function. In response to receiving a public information result 57 from the distributed ledger 22, the REST API 50 framework and can convert the result 57 to a text-based format, such as JavaScript Object Notation (JSON) format, and transmit the result to the content distributor 60. In response to receiving the result 57, the content distributor 60 can parse the result 57 and can extract the public metadata fields of result to identify the creator of the digital content element 30.

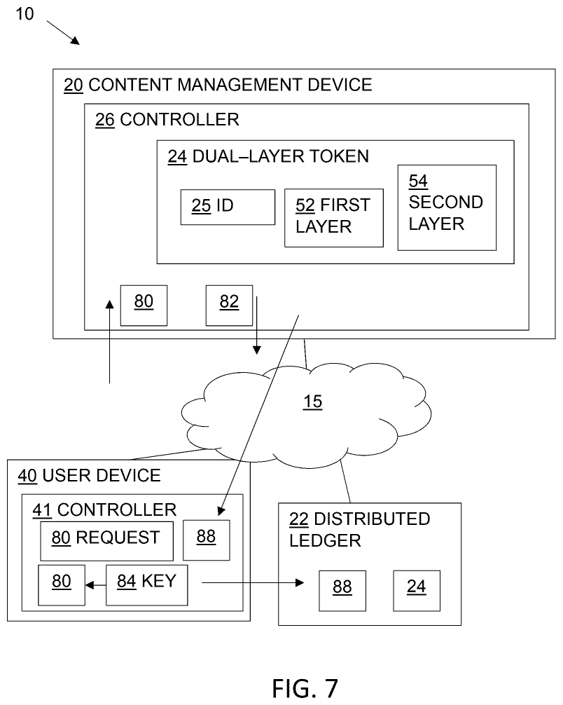

As such, by generating the REST API 50, the content management device 20 facilitates the provision of metadata associated with digital content element 30 in formats compatible with existing industry standards (e.g., ISRC, ISWC, CWR, DDEX), thereby enabling existing systems, such as service providers 40 or performing rights organizations, to query and integrate with the trustless backing layer without requiring replacement of the existing systems. This enables interoperability between previously siloed systems while maintaining compatibility with existing territory-specific copyright rules. As provided above, the content management device 20 is configured to generate the dual-layer token 24 as including private information 34 as part of a second layer 54. In certain cases, a rights holder associated with the digital content element 30 may want to view their private information (exact play counts, revenue splits, etc.). In one arrangement, to allow such access and with reference to FIG. 7, the content management device 20 is configured to verify the identity of the rights holder and to provide a private key 88 to the rights holder for access to the second layer 54 on the distributed ledger 22.

For example, the rights holder or requester can transmit, through a user device 40, a request 80 to access the second layer 54 of the universal rights dual-layer token 24 as associated with a digital content element 30. The request 80 can include a request for an access token, along with the unique identifier 25 associated with the digital content element 30.

In response to receiving the request 80, the content management device 20 is configured to verify the identity of the requester through a cryptographic signature. For example, the content management device 20 can generate a cryptographic challenge 82 and return the cryptographic challenge 82 to the user device 40. In response to receiving the cryptographic challenge 82, the requester can sign the cryptographic challenge 82 with a private key 84 to create a cryptographic signature 86 and can return the cryptographic signature 86 to the content management device 20.

In response to receiving the cryptographic signature 86, the content management device 20 can verify the identity of the requester, such as by determining the validity of the cryptographic signature 86. For example, the content management device 20 can compare a recovered address from the cryptographic signature 86, such as a wallet address of the user device 40 as associated with the digital content element 30 registered on the distributed ledger 22 to a claimed address, such as a wallet address of the of the user device 40 included in the cryptographic signature 86. Further, the content management device 20 can verify that the requester has access permissions to the second layer 54 on the distributed ledger 22. For example, the content management device 20 can review the second layer 54 of the dual-layer token 24 associated with the unique identifier 25 of the digital content element 30 to determine if the requester is listed as having an ownership share.

In response to verifying the cryptographic signature 86 as being valid, the content management device 20 can generate a second layer access token 88 and can forward the token 88 to the requester at the user device 40. While the second layer access token 88 can be configured in a variety of ways, in one arrangement the token 88 can include an address of the authenticated requester, the unique identifier 25 of the dual-layer token 24 that the requester is authorized to access, and an expiration time (e.g., 24 hours).

Following receipt of the second layer access key 88, the user device 40 can transmit the second layer access token 88 to the distributed ledger 22 as a request to access the second layer (i.e., private data). In turn, the distributed ledger 22 can validate the second layer access key 88 and, if validated, can return a response 89 to the user device 40. While the response 89 can be configured in a variety of ways, in one arrangement the response 89 can include a right's holder array with addresses and shares, an exact play count, revenue splits, territory rates, and AI training settings.

In one arrangement, in order to address use of a digital content element 30 as part of an artificial intelligence model training data set, the content management device 20 can integrate an artificial intelligence training permission status identifier as part of the second layer of the dual-layer token. The artificial intelligence training permission status identifier can be used to signify which works are being used in a training dataset to create a revenue path for derivative works, created from artificial intelligence (AI) by training on human works. This can also create a lineage for derivative works made from AI training and based upon the digital content element 30.

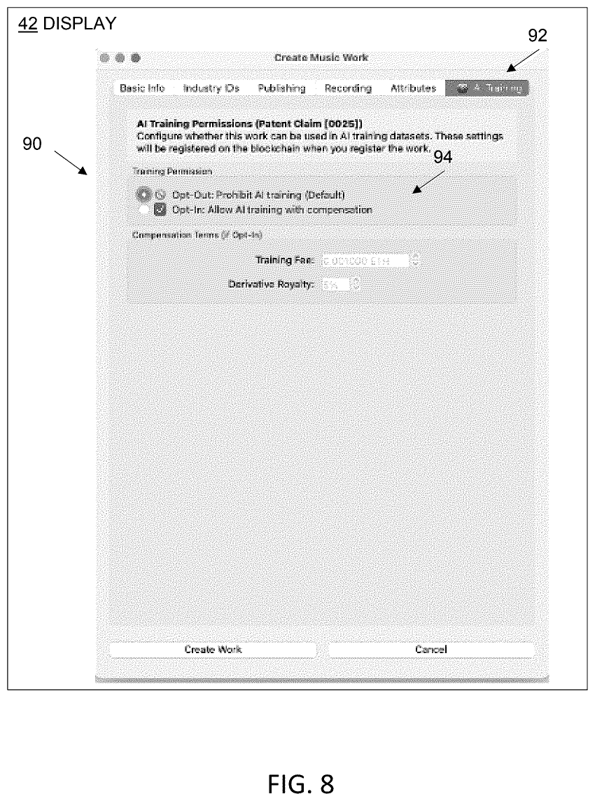

For example, with reference to FIG. 8, when a user registers a digital content element 30 as part of the content management system 10, the content management device 20 can provide a GUI 92, to the end user via a display 42, requesting the user to provide artificial intelligence training permission 90 related to the digital content element 30. As shown, the content management device 20 provides the artificial intelligence training permission 90 as an OPT IN or OPT OUT function for the use of the digital content element 30 as part of an artificial intelligence model training data set. Further, if the user decides to OPT IN to allowing the digital content element 30 to be used for AI training, the user can include compensation terms 94 associated with the use. Following selection, the content management device 20 can incorporate the resulting artificial intelligence training permission status identifier (i.e., OPT IN or OPT OUT) into the second layer 54 of the dual-layer token 54.

During operation, in the case where an AI company wanted to train their model on a particular digital content element 30, the AI company first queries a public API endpoint of a dual-layer token 24 associated with the digital content element 30 for training permissions. In response, a smart contract associated with the distributed ledger 22 checks the artificial intelligence training permission 90 setting associated with the dual-layer token 24. If the smart contract determines that the artificial intelligence training permission 90 is set to OPT OUT, the smart contract notifies the AI company that the digital content element 30 is not available for AI training. However, if the smart contract determines that the artificial intelligence training permission 90 is set to OPT IN, the smart contract can notify the AI company that the digital content element 30 is available for AI training and can forward the compensation terms 94 set by the user. Following payment of the fee listed in the compensation terms 94, the AI company creates a manifest of the digital content element 30 used for AI model training and commits the manifest to the distributed ledger 22. Further, if the AI company creates derivative works associated with the digital content element 30, they the AI company registers those derivative works on the distributed ledger 22 referencing the source digital content element 30.

As provided above, during operation, in the case where a user, such as a rights holder, wants to register a digital content element 30 with the system 10, the content management device 20 can provide a graphical user interface (GUI) 42 to the end user via a user device 40 and can request the user provide public and private information 32, 34 related to the digital content element 30. In certain cases, following recordation of the dual-layer token 24 on the distributed ledger 22, the user may want to update either the public or private information 32, 34 information (e.g., fix a typo in their name, update contact email, or transfer ownership shares, etc.). As such, in one arrangement, the content management device 20 is configured to update stored information dual-layer token 24 on the distributed ledger 22.

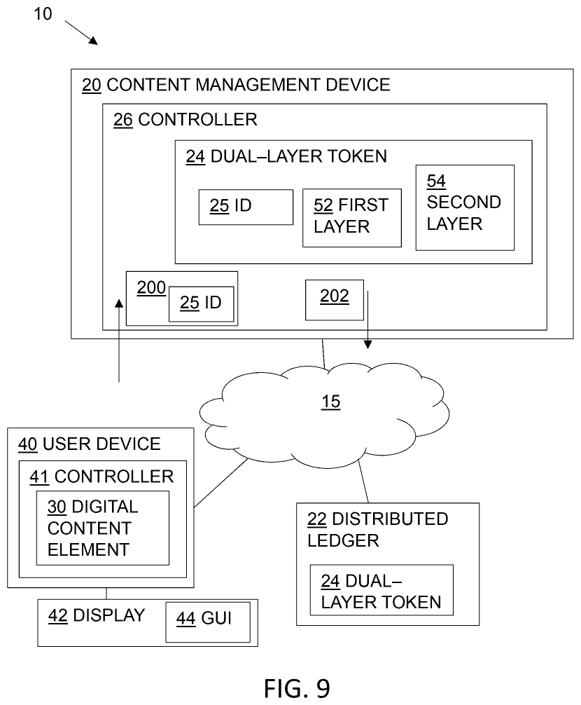

During operation, in one arrangement and with reference to FIG. 9, the content management device 20 is configured to receive a rights holder information update request 200 for a dual-layer token 24. In one arrangement, the user can transmit the update request 200 through the GUI 42 provided by the content management device 20. The update request 200 can be configured in a variety of ways. For example, the update request 200 can include the token identifier 25 associated with the dual-layer token 24 as well as the particular fields to be updated (e.g., name, IPI number, role, contact email) along with the updated information for those fields.

In response to receiving the update request 200, the content management device 20 is configured to authorize the rights holder information update request to update the dual-layer token 24. For example, the content management device 20 can review the second layer 54 of the dual-layer token 24 associated with the token identifier 25 to verify the requester is listed as a rights holder of the digital content element 30 (e.g., has a share in the digital content element >0).

Next, the content management device 20 is configured to, in response to authorizing the rights holder information update request 200, update rights holder information of the dual-layer token on the distributed ledger 22. For example, the content management device 20 can send an update transaction 202 to the distributed ledger 22 to call a smart contract of the distributed ledger 22 to update the particular fields of the dual-layer token 24 as requested by the user.

As provided above, during operation and in response to playing the digital content element 30, the content distributor 60 is configured to generate and forward the consumption event notification 70 to the content management device 20. Such description is by way of example only. In one arrangement, digital content element 30 can have an embedded trigger, such as a smart contract, such that interaction with the digital content element 30 (e.g., playing of the digital audio file) causes the trigger or smart contract to send the consumption event notification 70 to the content management device 20. As such, the smart contract is configured to facilitate relatively rapid IP rights management and administration. With conventional payment schemes associated with the use of digital content, it can take up to eighteen months for a rights holder to be notified of payment. With use of the digital content element 30 having the integrated trigger or smart contract, rights holders can be notified immediately following the use of the digital content element 30.

While various embodiments of the innovation have been particularly shown and described, it will be understood by those skilled in the art that various changes in form and details may be made therein without departing from the spirit and scope of the innovation as defined by the appended claims.

What is claimed is:

1. In a content management device, a method of managing interaction with a digital content element, comprising:
receiving, by the content management device, public information associated with the digital content element and private information associated with the digital content element to register the digital content element with the content management device;
generating, by the content management device, a dual-layer token having a first layer based upon the public information associated with the digital content element and a second layer based upon the private information associated with the digital content element;
registering, by the content management device, the dual-layer token on a distributed ledger;
receiving, by the content management device, consumption event notifications associated with digital content elements registered with the content management device;
registering, by the content management device, the consumption event notifications as a notification batch on the distributed ledger, the notification batch providing immutable proof of a consumption event for a digital content element registered with the content management device; and
generating, by the content management device, a compensation report related to consumption of the digital content element, the compensation report identifying the dual-layer token and the notification batch registered on the distributed ledger.

2. The method of claim 1, wherein:
receiving public information associated with the digital content element comprises receiving, by the content management device, at least one of a title, artist name, content description, music type, duration, or technical specification associated with the digital content element; and
receiving private information associated with the digital content element comprises receiving, by the content management device, at least one of an ownership percentage and a revenue allocation structure associated with the digital content element.

3. The method of claim 1, wherein generating the universal rights dual-layer token having a first layer based upon public information and a second layer based upon private information comprises generating, by the content management device, the universal rights dual-layer token having:
a unique identifier associated with the digital content element;
a first layer based upon the public information; and
a second layer based upon the private information, the second layer configured to identify ownership information and transaction information with respect to the digital content element.

4. The method of claim 1, wherein receiving consumption event notifications associated with digital content elements registered with the content management device comprises:
generating, by the content management device, a consumption event hash for each consumption event notification;
organizing, by the content management device, each consumption event hash into a binary tree; and
pairing, by the content management device, adjacent consumption event hashes until a single root hash remains, the single root hash representing a proof of consumption of the digital content elements.

5. The method of claim 4, wherein registering the consumption event notifications as the notification batch on the distributed ledger comprises registering, by the content management device, the single root hash to the distributed ledger.

6. The method of claim 1, wherein receiving consumption event notifications associated digital content elements registered with the content management device comprises receiving, by the content management device and for each consumption event notification, a unique identifier associated with the digital content element, a content distributor identifier, a timestamp associated with a time of the consumption event, and a geographic origination identifier associated with the consumption event and indicating a geographic location associated with use of the digital content element.

7. The method of claim 1, wherein the first layer further comprises a Representational State Transfer (REST) application programming interface (API), the REST API configured to provide public information metadata associated with a digital content element based upon a third-party request.

8. The method of claim 1, further comprising:
receiving, by the content management device, a request to access the second layer of the universal rights dual-layer token from a requester;
verifying, by the content management device, an identity of the requester through a cryptographic signature;
in response to verifying the requester identity, generating, by the content management device, a second layer access token; and
forwarding, by the content management device, the second layer access token to the requester.

9. The method of claim 1, wherein receiving private information associated with the digital content element comprises receiving, by the content management device, an artificial intelligence training permission status identifier.

10. The method of claim 1, further comprising:
receiving, by the content management device, a rights holder information update request;
authorizing, by the content management device, the rights holder information update request; and
in response to authorizing the rights holder information update request, updating, by the content management device, rights holder information of the dual-layer token on the distributed ledger.

11. A content management device, comprising:
a controller having a memory and a processor, the controller configured to:
receive public information associated with the digital content element and private information associated with the digital content element to register the digital content element with the content management device;
generate a dual-layer token having a first layer based upon the public information associated with the digital content element and a second layer based upon the private information associated with the digital content element;
register the dual-layer token on a distributed ledger;
receive consumption event notifications associated with digital content elements registered with the content management device;
register the consumption event notifications as a notification batch on the distributed ledger, the notification batch providing immutable proof of a consumption event for a digital content element registered with the content management device; and
generate a compensation report related to consumption of the digital content element, the compensation report identifying the dual-layer token and the notification batch registered on the distributed ledger.

12. The content management device of claim 10, wherein:
when receiving public information associated with the digital content element, the controller is configured to receive at least one of a title, artist name, content description, music type, duration, or technical specification associated with the digital content element; and
when receiving private information associated with the digital content element, the controller is configured to receive at least one of an ownership percentage and a revenue allocation structure associated with the digital content element.

13. The content management device of claim 10, wherein when generating the universal rights dual-layer token having a first layer based upon public information and a second layer based upon private information, the controller is configured to generate the universal rights dual-layer token having:
a unique identifier associated with the digital content element;
a first layer based upon the public information; and
a second layer based upon the private information, the second layer configured to identify ownership information and transaction information with respect to the digital content element.

14. The content management device of claim 10, wherein when receiving consumption event notifications associated with digital content elements registered with the content management device, the controller is configured to:
generate a consumption event hash for each consumption event notification;
organize each consumption event hash into a binary tree; and
pair adjacent consumption event hashes until a single root hash remains, the single root hash representing a proof of consumption of the digital content elements.

15. The content management device of claim 14, wherein when registering the consumption event notifications as the notification batch on the distributed ledger, the controller is configured to register the single root hash to the distributed ledger.

16. The content management device of claim 10, wherein when receiving consumption event notifications associated digital content elements registered with the content management device, the controller is configured to receive, for each consumption event notification, a unique identifier associated with the digital content element, a content distributor identifier, a timestamp associated with a time of the consumption event, and a geographic origination identifier associated with the consumption event and indicating a geographic location associated with use of the digital content element.

17. The content management device of claim 10, wherein the first layer further comprises a Representational State Transfer (REST) application programming interface (API), the REST API configured to provide public information metadata associated with a digital content element based upon a third-party request.

18. The content management device of claim 10, wherein the controller is further configured to:
receive a request to access the second layer of the universal rights dual-layer token from a requester;
verify an identity of the requester through a cryptographic signature;
in response to verifying the requester identity, generate a second layer access token; and
forward the second layer access token to the requester.

19. The content management device of claim 10, wherein when receiving private information associated with the digital content element, the controller is configured to receive an artificial intelligence training permission status identifier.

20. The content management device of claim 10, wherein the controller is further configured to:
receive a rights holder information update request;
authorize the rights holder information update request; and
in response to authorizing the rights holder information update request, update rights holder information of the dual-layer token on the distributed ledger.
